(19) United States
(12) Patent Application Publication
(10) Pub. No.: US 2012/0145912 A1
(43) Pub. Date: Jun. 14, 2012

(54) RADIOLOGICAL IMAGE DETECTION APPARATUS, RADIOGRAPHIC APPARATUS AND RADIOGRAPHIC SYSTEM

(75) Inventors: Naoto IWAKIRI, Kanagawa (JP); Masaru Sato, Kanagawa (JP)

(73) Assignee: FUJIFILM Corporation, Tokyo (JP)

(21) Appl. No.: 13/306,100

(22) Filed: Nov. 29, 2011

(30) Foreign Application Priority Data
Dec. 8, 2010 (JP) 2010-274146

(51) Int. Cl. G01T 1/24; G01T 1/17

(52) U.S. Cl. 250/370.08; 250/336.1

(57) ABSTRACT

A radiological image detection apparatus includes a first grating, a second grating, a scanning unit, a radiological image detector, a radiation detection unit, and a control unit. The scanning unit relatively displaces at least one of the radiological image and the second grating to a plurality of relative positions at which phase differences of the radiological image and the second grating are different from each other. The radiation detection unit is provided on a path of the radiation and detects the radiation irradiated to the radiological image detector. The control unit allows the scanning unit to perform a relative displacement operation of the first grating and the second grating in a time period in which a radiation dose detection value of the radiation detected by the radiation detection unit is attenuated to a given level.

### CROSS-REFERENCE TO RELATED APPLICATIONS

This application claims the benefit of Japanese Patent Application No. 2010-274146 (filed on Dec. 8, 2010), the entire contents of which are hereby incorporated by reference.

### BACKGROUND

1. Technical Field

The invention relates to a radiological image detection apparatus, a radiographic apparatus and a radiographic system.

2. Description of Related Art

Since X-ray attenuates depending on an atomic number of an element configuring a material and a density and a thickness of the material, it is used as a probe for seeing through an inside of a photographic subject. An imaging using the X-ray is widely spread in fields of medical diagnosis, nondestructive inspection and the like.

In a general X-ray imaging system, a photographic subject is arranged between an X-ray source that irradiates the X-ray and an X-ray image detector that detects the X-ray, and a transmission image of the photographic subject is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto each pixel of the X-ray image detector. As a result, an X-ray absorption image of the photographic subject is detected and captured by the X-ray image detector. As the X-ray image detector, a flat panel detector (FPD) that uses a semiconductor circuit is widely used in addition to a combination of an X-ray intensifying screen and a film and a photostimulable phosphor.

However, the smaller the atomic number of the element configuring material, the X-ray absorption ability is reduced. Accordingly, for the soft biological tissue or soft material, it is not possible to acquire the contrast of an image that is enough for the X-ray absorption image. For example, the cartilaginous part and joint fluid configuring an articulation of the body are mostly comprised of water. Thus, since a difference of the X-ray absorption amounts thereof is small, it is difficult to obtain the shading difference. Up to date, the soft tissue can be imaged by using the MRI (Magnetic Resonance Imaging). However, it takes several tens of minutes to perform the imaging and the resolution of the image is low such as about 1 mm. Hence, it is difficult to use the MRI in a regular physical examination such as medical checkup due to the cost-effectiveness.

Regarding the above problems, instead of the intensity change of the X-ray by the photographic subject, a research on an X-ray phase imaging of obtaining an image (hereinafter, referred to as a phase contrast image) based on a phase change (refraction angle change) of the X-ray by the photographic subject has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having a low X-ray absorption ability. Up to date, regarding the X-ray phase imaging, it has been possible to perform the imaging by generating the X-ray having a wavelength and a phase with a large-scaled synchrotron radiation facility (for example, SPring-8) using an accelerator, and the like. However, since the facility is too huge, it cannot be used in a usual hospital. As the X-ray phase imaging to solve the above problem, an X-ray imaging system has been recently suggested which uses an X-ray Talbot interferometer having two transmission diffraction gratings (phase type grating and absorption type grating) and an X-ray image detector (for example, refer to JP-2008-200359-A).

The X-ray Talbot interferometer includes a first diffraction grating G1 (phase type grating or absorption type grating) that is arranged at a rear side of a photographic subject, a second diffraction grating G2 (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating G1 forms a self-image by the Talbot interference effect. The self-image is modulated by the interaction (phase change) of the photographic subject, which is arranged between the X-ray source and the first diffraction grating, and the X-ray.

In the X-ray Talbot interferometer, a moiré fringe that is generated by superposition between the self-image of the first diffraction grating G1 and the second diffraction grating G2 is detected and a change of the moiré fringe by the photographic subject is analyzed, so that phase information of the photographic subject is acquired. As the analysis method of the moiré fringe, a fringe scanning method has been known, for example. According to the fringe scanning method, a plurality of imaging is performed while the second diffraction grating G2 is translation-moved with respect to the first diffraction grating G1 in a direction, which is substantially parallel with a plane of the first diffraction grating G1 and is substantially perpendicular to a grating direction (strip band direction) of the first diffraction grating G1, with a scanning pitch that is obtained by equally partitioning the grating pitch. Then, an angle distribution (differential image of a phase shift) of the X-ray refracted at the photographic subject is acquired from changes of signal values of respective pixels obtained in the X-ray image detector. Based on the acquired angle distribution, it is possible to obtain a phase contrast image of the photographic subject.

According to the phase contrast image that is obtained as described above, it is possible to capture an image of the tissue (cartilage, soft part) that cannot be imaged because the absorption difference is too small and thus the contrast difference is little according to the conventional imaging method based on the X-ray absorption. In particular, while the absorption difference is little obtained between the cartilage and the joint fluid according to the X-ray absorption method, a clear contrast is made according to the X-ray phase (refraction) imaging, so that an image thereof can be captured. Thereby, it is possible to rapidly and easily diagnose the knee osteoarthritis that most of the aged (about 30 million persons) are regarded to have, the arthritic disease such as meniscus injury due to sports disorders, the rheumatism, the Achilles tendon injury, the disc hernia and the soft tissue such as breast tumor mass by the X-ray. Hence, it is expected that it is possible to contribute to the early diagnosis and the early treatment of the potential patient and the reduction of the medical care cost.

The X-ray phase (refraction) imaging is to perform a plurality of imaging while stepwise moving the second diffraction grating G2 and to restore the phase of the X-ray incident onto the respective pixels from a plurality of intensity values for the respective pixels, which are obtained from the respective captured images, thereby forming a phase contrast image.

Thus, according to the X-ray imaging system of JP-2008-200359-A, when stopping the irradiation of the X-ray every imaging, the power supply to an X-ray tube is stopped. However, since there is a time constant occurring next time in the X-ray system, the power is continuously supplied for a while even after the power supply is stopped, so that it is not possible to immediately stop the X-ray. That is, a remaining output (which is also referred to as wave tail) exists for some while in the output of the X-ray tube.

When a tube current flowing to the X-ray tube is I and a tube voltage is V, an apparent resistance R of the X-ray tube is expressed by R=V/I. Also, when a capacity of the X-ray tube is CTube[pF], a capacity of an X-ray cable is Cline[pF/m] and a cable length is L, a capacity C of the X-ray system can be obtained by C=CTube+Cline×L. In this case, the time constant τ of the X-ray system can be obtained by τ=RC.

For example, in order to obtain the contrast of the soft tissue, when the tube voltage is set as 50 kV and the tube current is set as 50 mA, the resistance R is 1×106. Also, when the capacity CTube of the X-ray tube is about 500 to 1500 pF, representatively 500 pF, the capacity Cline of the X-ray cable is about 100 to 200 pF, representatively 150 pF/m, and the cable length is set as 20 m, the capacity C of the X-ray system is 3,500 pF. Therefore, the time constant τ is 3.5 msec and the time of the wave tail is several tens of ms when it is set to be three to five times than the time constant τ, as the sufficient attenuation time of the X-ray.

When performing a plurality of imaging with respect to the X-ray phase (refraction) imaging, the imaging should be performed in a short time because a patient cannot typically keep still for a long time due to the diseases. Accordingly, in order to perform the imaging at a rate of 2 to 30 images per second, it is necessary that the irradiation time of the X-ray should be 20 msec or shorter. In this case, even when the irradiation time is 20 msec or shorter, if the wave tail exists for several tens of ms, a ratio of the time of the wave tail to the entire irradiation time is not negligible. When the second diffraction grating G2 is driven in a time zone in which the X-ray by the wave tail is generated, a distance between the first diffraction grating G1 and the second diffraction grating G2 is changed by the moving of the second diffraction grating G2, so that a moiré fringe is varied. The variation of the moiré fringe is superimposed on the pattern of the original moiré fringe by the phase difference/refractive index difference, so that a calculation error is caused when reconstructing an image of the phase difference/refractive index difference after performing the imaging.

Accordingly, when generating a phase contrast image, the contrast or resolution is lowered and the artifact in which the variation of the moiré fringe cannot be perfectly removed is generated, so that the diagnosis ability is remarkably deteriorated. Also, when the imaging is not performed until the wave tail naturally converges, it takes much time to complete the plurality of imaging, so that the shaking due to the moving of the patient is also caused. Also, regarding the moving of the second diffraction grating G2, since the moving speed of the second diffraction grating G2 is exceedingly responsive at the time of rising, the moving speed is not the constant speed. If the X-ray by the wave tail is generated when the moving speed is excessive, the component by the corresponding influence is also superimposed on the image, so that the pattern of the stable moiré fringe cannot be obtained. In addition, the position difference of the X-ray due to the change of the phase shift/refractive index, which is caused when the X-ray penetrates the photographic subject, is slight such as about 1 μm and a little variation of the intensity value also highly influences the phase restoring accuracy.

Like this, the influence of the wave tail on the X-ray phase (refraction) imaging is much higher, compared to the typical still image of the X-ray or moving picture imaging in which images are not reconstructed by calculation from the slight changes of the images. Also, even compared to the technique of capturing a plurality of images in which the images of the photographic subject are largely changed while changing the incident angle of the X-ray onto the photographic subject and then reconstructing the images, such as CT or Tomosynthesis, the above influence is very high. The reason is as follows. In the phase contrast image, the slight position difference of the X-ray such as about 1 μm, which is caused due to the phase shift/refractive index change of the X-ray, is captured as the moiré superimposition on the photographic subject image while translation-moving the second grating without changing the incident angle of the X-ray onto the photographic subject. However, the image itself of the photographic subject is little changed, so that the phase contrast image is reconstructed from the slight image changes between the images. Accordingly, even compared to the image capturing of performing the reconstruction, such as CT or Tomosynthesis of calculating the reconstruction image from the plurality of images in which the images of the photographic subject are largely changed because the incident angle of the X-ray is changed, the influence of the slight image change on the phase contrast image is high. Also in an energy subtraction imaging technique of reconstructing an energy absorption distribution from photographic subject images of different energies at the same X-ray incident angle and thus separating soft tissue, bone tissue and the like, the imaging energies are different in the energy subtraction images, so that the photographic subject contrasts are largely changed between the images. Thus, the phase contrast image is highly influenced by the variation of the slight image change accompanied by the moving of the second diffraction grating during the X-ray generation by the wave tail.

The invention has been made to solve the above problems. An object of the invention is to remove an influence of a wave tail of a tube voltage waveform and to thus improve a quality of a radiological phase contrast image when performing a phase imaging by radiation such as X-ray.

### SUMMARY OF INVENTION

According to an aspect of the invention, a radiological image detection apparatus includes a first grating, a second grating, a scanning unit, a radiological image detector, a radiation detection unit, and a control unit. The second grating has a periodic form which substantially coincides with a pattern period of a radiological image formed by radiation having passed through the first grating. The scanning unit relatively displaces at least one of the radiological image and the second grating to a plurality of relative positions at which phase differences of the radiological image and the second grating are different from each other. The radiological image detector detects the radiological image masked by the second grating. The radiation detection unit is provided on a path of the radiation and detects the radiation to be irradiated to the radiological image detector. The control unit allows the scanning unit to perform a relative displacement operation of the first grating and the second grating in a time period in which a radiation dose detection value of the radiation detected by the radiation detection unit is attenuated to a given level at which the radiation dose value does not have a substantial effect on an image of the radiological image detector.

According to the invention, in the phase imaging by the radiation such as X-ray, the scanning unit is allowed to perform the relative displacement operation of the first grating and the second grating in the time period in which the radiation dose detection value of the radiation, which is detected by the radiation detection unit, is attenuated to a radiation dose value that does not have a substantial effect on an image of the radiological image detector. Thus, it is possible to prevent the wave tail of the tube voltage waveform from influencing the captured image. Thereby, it is possible to improve a quality of the radiological phase contrast image to be obtained.

### BRIEF DESCRIPTION OF THE DRAWINGS

FIG. 1 is a pictorial view showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector of the radiographic system of FIG. 1.

FIG. 4 is a perspective view of an imaging unit of the radiographic system of FIG. 1.

FIG. 5 is a side view of the imaging unit of the radiographic system of FIG. 1.

FIGS. 6A, 6B and 6C are pictorial views showing a mechanism for changing a period of a moiré fringe resulting from superposition of first and second gratings.

FIG. 7 is a pictorial view for illustrating refraction of radiation by a photographic subject.

FIG. 8 is a pictorial view for illustrating a fringe scanning method.

FIG. 9 is a graph showing pixel signals of the radiological image detector in accordance with the fringe scanning.

FIG. 10 is a sectional view of a photo timer of an ionization chamber type.

FIG. 11 is a control block diagram when an exposure control is performed by using the photo timer.

FIG. 12 illustrates a relation of a waveform of a tube voltage that is applied to an X-ray source, a detection signal of the photo timer and a moving amount of a grating by a scanning mechanism.

FIG. 13 illustrates an arrangement position of the photo timer.

FIG. 14 is a circuit diagram of an imaging circuit of an FPD having an X-ray detection unit.

FIG. 15 is a pictorial view showing another example of a configuration of a radiographic system for illustrating an illustrative embodiment of the invention.

FIG. 16 is a pictorial view showing a configuration of a modified embodiment of the radiographic system of FIG. 15.

FIG. 17 is a pictorial view showing another example of a configuration of a radiographic system for illustrating an illustrative embodiment of the invention.

FIG. 18 is a block diagram showing a configuration of a calculation unit that generates a radiological image, in accordance with another example of a radiographic system for illustrating an illustrative embodiment of the invention.

FIG. 19 is a graph showing pixel signals of the radiological image detector for illustrating a process in the calculation unit of the radiographic system shown in FIG. 18.

### DETAILED DESCRIPTION

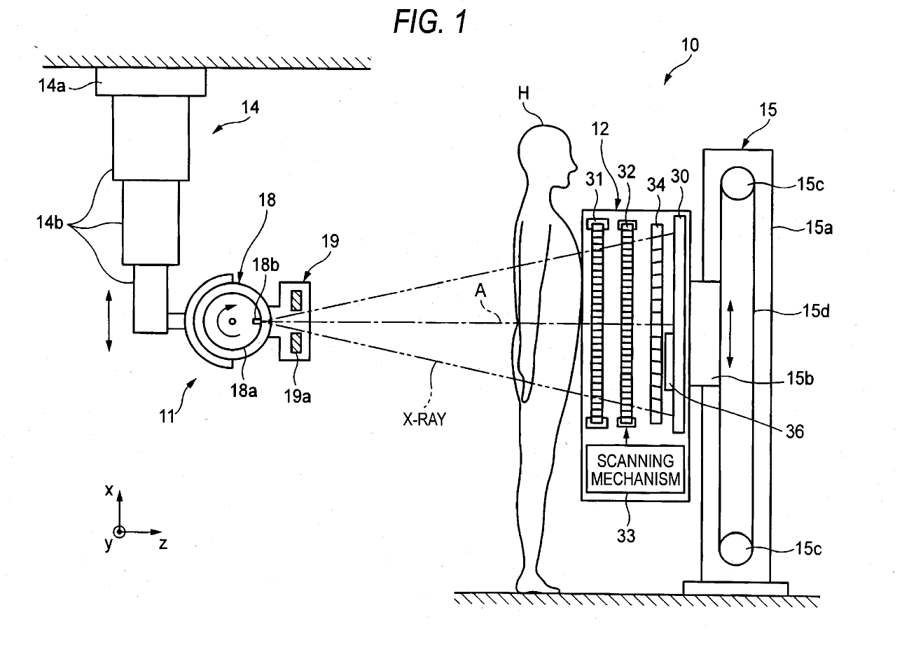

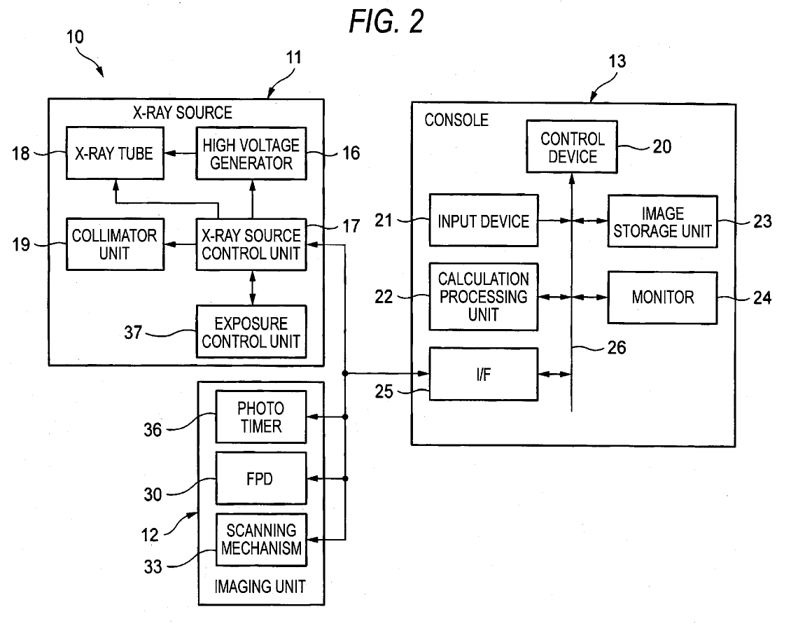

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging for a photographic subject (patient) H while the patient stands, and includes an X-ray source 11 that X-radiates the photographic subject H, an imaging unit 12 that is opposed to the X-ray source 11, detects the X-ray having penetrated the photographic subject H from the X-ray source 11 and thus generates image data and a console 13 that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17, and a collimator unit 19 having a moveable collimator 19a that limits an irradiation field so as to shield a part of the X-ray generated from the X-ray tube 18, which part does not contribute to an inspection area of the photographic subject H. The X-ray tube 18 is a rotary anode type that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focus 18b.

The X-ray source holding device 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that has a semiconductor circuit, and a first absorption type grating 31 and a second absorption type grating 32 that detect a phase change (angle change) of the X-ray by the photographic subject H and perform a phase imaging. Also, a photo timer 36 functioning as an X-ray detection unit is arranged in a gap that does not interference with a scanning mechanism 33 between the FPD 30 and the second absorption type grating 32. The photo timer 36 detects an amount of charges that are ionized by the X-ray and outputs a signal current, which is generated by the charges, to an exposure control unit 37.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

Also, the imaging unit 12 is provided with a scanning mechanism 33 that translation-moves the second absorption type grating 32 in the upper-lower (x direction) and thus changes a relative position relation of the second absorption type grating 32 to the first absorption type grating 31. The scanning mechanism 33 consists of an actuator such as piezoelectric device, for example.

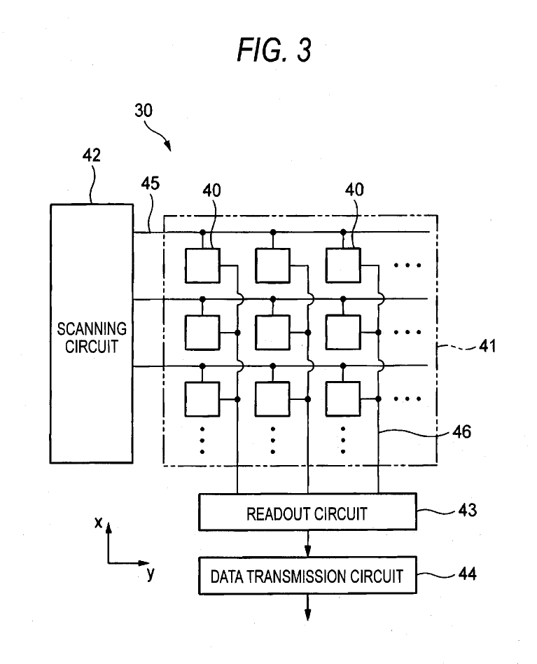

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the OF 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode of the conversion layer. Each pixel 40 is connected with a TFT switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of terbium-doped gadolinium oxysulfide (Gd₂O₂S:Tb), thallium-doped cesium iodide (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

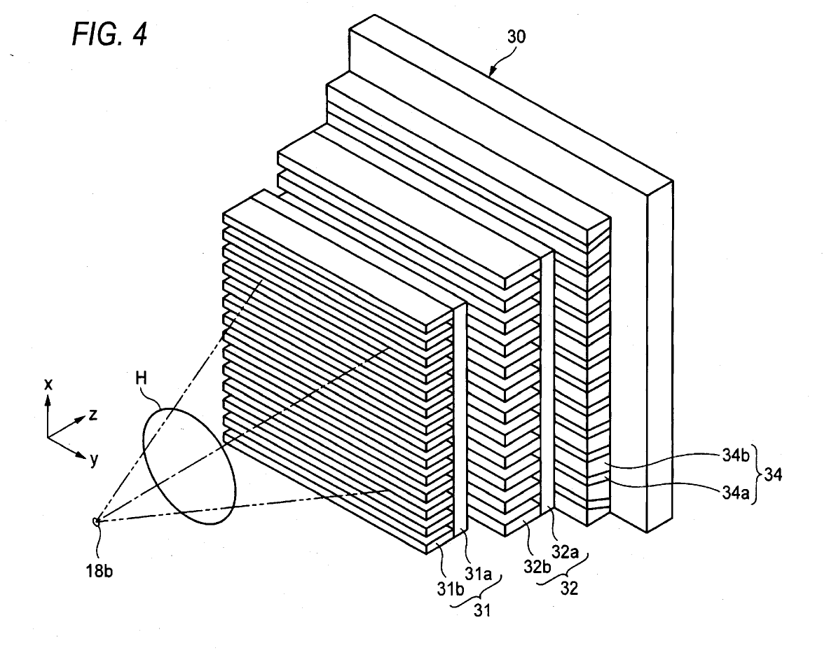

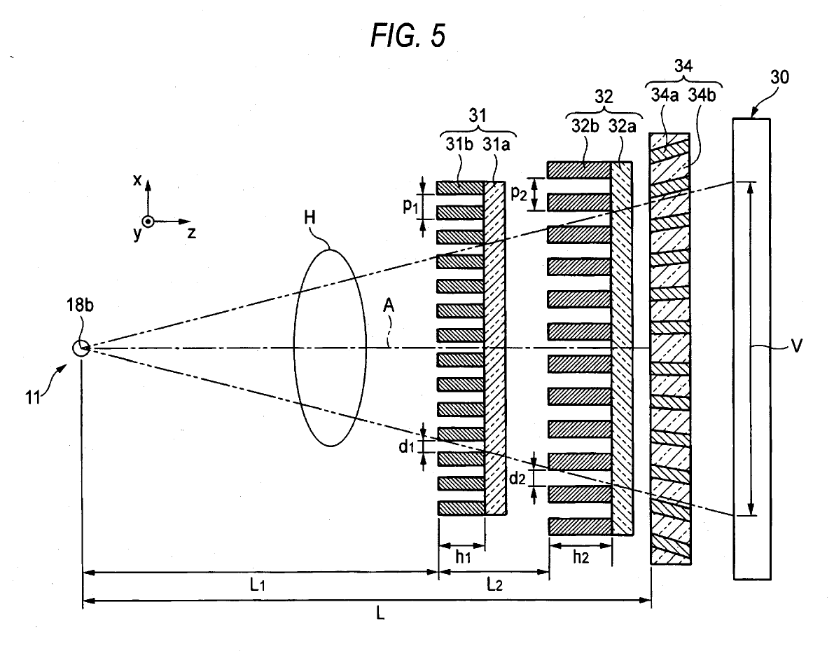

FIGS. 4 and 5 show the imaging unit of the radiographic system of FIG. 1.

The first absorption type grating 31 has a X-ray transmission unit (a substrate) 31a and a plurality of X-ray shield units 31b arranged on the X-ray transmission unit 31a. Likewise, the second absorption type grating 32 has a X-ray transmission unit (a substrate) 32a and a plurality of X-ray shield units 32b arranged on the X-ray transmission unit 32a. The X-ray transmission units 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p1 and at a predetermined interval d1 in the direction (x direction) orthogonal to the one direction. Likewise, the X-ray shield units 32b are arranged on the in-plane orthogonal to the optical axis A of the X-ray with a constant pitch p2 and at a predetermined interval d2 in the direction (x direction) orthogonal to the one direction. Since the first and second absorption type gratings 31, 32 provide the incident X-ray with an intensity difference, rather than the phase difference, they are also referred to as amplitude type gratings. In the meantime, the slit (area of the interval d1 or d2) may not be a void. For example, the void may be filled with X-ray low absorption material such as high molecule or light metal.

The first and second absorption type gratings 31, 32 are adapted to geometrically project the X-ray having passed through the slits, regardless of the Talbot interference effect. Specifically, the intervals d1, d2 are set to be sufficiently larger than a peak wavelength of the X-ray irradiated from the X-ray source 11, so that most of the X-ray included in the irradiated X-ray is enabled to pass through the slits while keeping the linearity thereof, without being diffracted in the slits. For example, when the rotary anode 18a is made of tungsten and the tube voltage is 50 kV, the peak wavelength of the X-ray is about 0.4 Å. In this case, when the intervals d1, d2 are set to be about 1 to 10 most of the X-ray is geometrically projected in the slits without being diffracted.

Since the X-ray irradiated from the X-ray source 11 is a conical beam having the X-ray focus 18b as an emitting point, rather than a parallel beam, a projection image (hereinafter, referred to as G1 image), which has passed through the first absorption type grating 31 and is projected, is enlarged in proportion to a distance from the X-ray focus 18b. The grating pitch p2 and the interval d2 of the second absorption type grating 32 are determined so that the slits substantially coincide with a periodic pattern of bright parts of the G1 image at the position of the second absorption type grating 32. That is, when a distance from the X-ray focus 18b to the first absorption type grating 31 is L1 and a distance from the first absorption type grating 31 to the second absorption type grating 32 is L2, the grating pitch p2 and the interval d2 are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L2 from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L2 irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p1 of the first absorption type grating 31, the grating pitch p2 of the second absorption type grating 32, the X-ray wavelength (peak wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known by Atsushi Momose, et al. (Japanese Journal of Applied Physics, Vol. 47, No. 10, 2008, August, page 8077).

In the X-ray imaging system 10, the distance L2 is set to be shorter than the minimum Talbot interference distance Z when m=1 so as to make the imaging unit 12 smaller. That is, the distance L2 is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L2 is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having excellent X-ray absorption ability are used, many X-rays penetrate the X-ray shield units without being absorbed. Accordingly, in order to improve the shield ability of X-ray, it is preferable to make thickness h1, h2 of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h1, h2 are preferably 30 μm or larger, based on gold (Au).

In the meantime, when the thickness h1, h2 of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h1, h2 are defined. In order to secure a length V of the effective field of view in the x direction on the detection surface of the FPD 30, when a distance from the X-ray focus 18b to the detection surface of the FPD 30 is L, the thickness h1, h2 are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d1=2.5 μm, d2=3.0 μm and L=2 m, assuming a typical diagnose in a typical hospital, the thickness h1 should be 100 μm or smaller and the thickness h2 should be 120 μm or smaller so as to secure a length of 10 cm as the length V of the effective field of view in the x direction.

The X-ray shield unit 31b is made of a band-shaped member that extends in the in-plane one direction (in the shown example, y direction) orthogonal to the optical axis A of the X-ray irradiated from the X-ray source 11. As the materials of the X-ray shield unit 31b, materials having excellent X-ray absorption ability are preferable. For example, a metal foil such as lead, copper, tungsten and the like is used. The X-ray shield units 31b are arranged on the in-plane orthogonal to the optical axis A of the X-ray at an interval in the direction (x direction) orthogonal to the one direction. The X-ray transmission units 31a are provided to fill between the neighboring X-ray shield units 31b. As the materials of the X-ray transmission unit 31a, materials having X-ray low absorption ability are preferable. For example, high molecule or light metal is used.

In the imaging unit 12 configured as described above, an intensity-modulated image is formed by the superimposition of the G1 image of the first absorption type grating 31 and the second absorption type grating 32 and is captured by the FPD 30. A pattern period p1′ of the G1 image at the position of the second absorption type grating 32 and a substantial grating pitch p2′ (substantial pitch after the manufacturing) of the second absorption type grating 32 are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p1′ of the G1 image and the grating pitch p2′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p1′ of the G1 image and the grating pitch p2′, thereby changing the moiré period T.

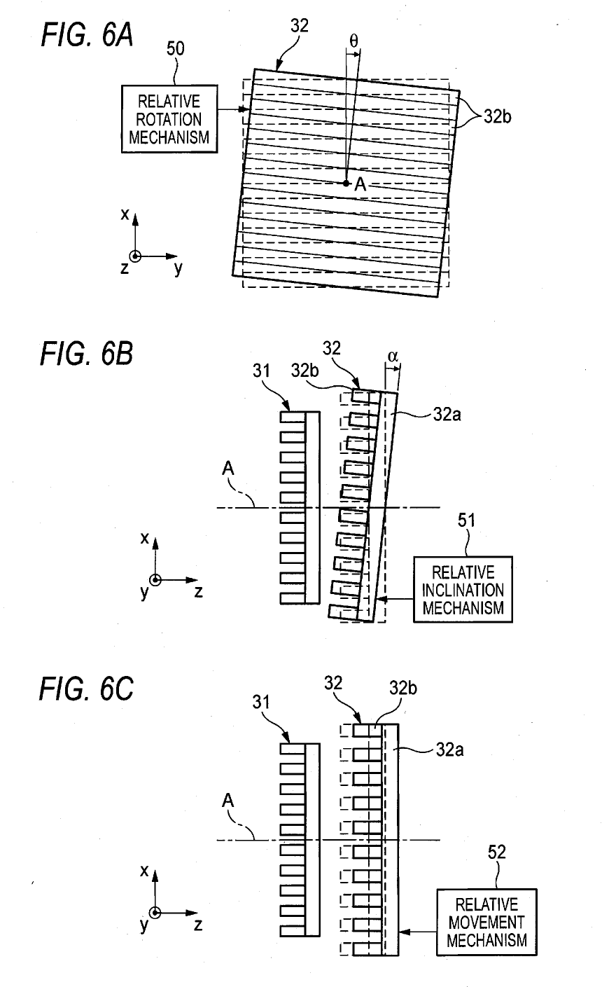

FIGS. 6A, 6B and 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p2”' to “p2′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p2”' to “p2′×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L2 between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p1” to “p1′×(L1+L2+δ)/(L1+L2)”, so that the moiré period T is changed (refer to FIG. 6C).

In the X-ray imaging system 10, since the imaging unit 12 is not the Talbot interferometer and can freely set the distance L2, it can appropriately adopt the mechanism for changing the distance L2 to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

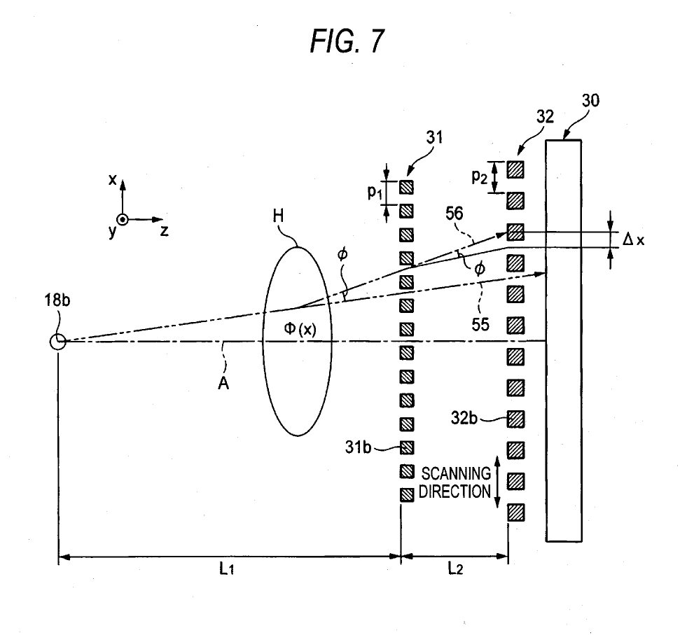

FIG. 7 shows one X-ray that is refracted in correspondence to a phase shift distribution Φ(x) in the x direction of the photographic subject H. In the meantime, an anti-scatter grid is not shown.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (12), when a refractive index distribution of the photographic subject H is indicated by n(x, z) and the traveling direction of the X-ray is indicated by z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) using a wavelength λ of the X-ray and the phase shift distribution Φ(x) of the photographic subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase difference amount ψ of a signal output from each pixel 40 of the FPD 40 (a difference amount of a phase of a signal of each pixel 40 when there is the photographic subject H and when there is no photographic subject H), as expressed by a following equation (15).

$$\begin{matrix}[ equation 15 ] & \\ ψ = \frac{2 π}{{p}_{2}} Δ x = \frac{2 π}{{p}_{2}} {L}_{2} ϕ & ( 15 )\end{matrix}$$

Therefore, when the phase difference amount ψ of a signal of each pixel 40 is calculated, the refraction angle φ is obtained from the equation (15) and a differential of the phase shift distribution Φ(x) is obtained by using the equation (14). Hence, by integrating the differential with respect to x, it is possible to generate the phase shift distribution Φ(x) of the photographic subject H, i.e., the phase contrast image of the photographic subject H. In the X-ray imaging system 10 of this illustrative embodiment, the phase difference amount ψ is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance (moving amount in the x direction) reaches one period (grating pitch p2) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p2, the fringe images are captured by the FPD 30 and the signals of the respective pixels 40 are obtained from the captured fringe images and calculated in the calculation processing unit 22, so that the phase difference amount ψ of the signal of each pixel 40 is obtained.

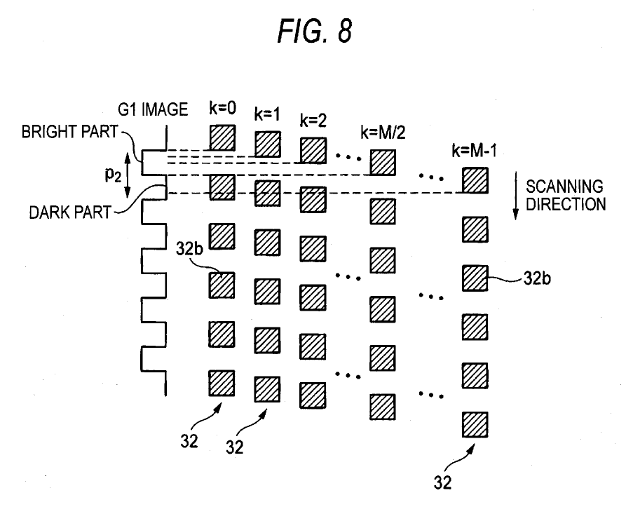

FIG. 8 pictorially shows that the second absorption type grating 32 is moved with a scanning pitch (p2/M) (M: integer of 2 or larger) that is obtained by dividing the grating pitch p2 into M.

The scanning mechanism 33 sequentially translation-moves the second absorption type grating 32 to each of M scanning positions of k=0, 1, 2, . . . M−1. In FIG. 8, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values are obtained for the respective pixels 40. In the below, a method of calculating the phase difference amount ψ of the signal of each pixel 40 from the M signal values is described. When a signal value of each pixel 40 at the position k of the second absorption type grating 32 is indicated with Ik(x), Ik(x) is expressed by a following equation (16).

$$\begin{matrix}[ equation 16 ] & \\ {I}_{k} ( x ) = {A}_{0} + {\sum }_{n > 0} {A}_{n} exp [ 2 πi \frac{n}{{p}_{2}} \{ {L}_{2} ϕ ( x ) + \frac{k {p}_{2}}{M} \} ] & ( 16 )\end{matrix}$$

Here, x is a coordinate of the pixel 40 in the x direction, A0 is the intensity of the incident X-ray and An is a value corresponding to the contrast of the signal value of the pixel 40 (n is a positive integer). Also, φ(x) indicates the refraction angle φ as a function of the coordinate x of the pixel 40.

Then, when a following equation (17) is used, the refraction angle φ(x) is expressed by a following equation (18).

$$\begin{matrix}[ equation 17 ] & \\ {\sum }_{k = 0}^{M - 1} exp ( - 2 π i \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg[ ] is a symbol of an operation which means the calculation of an argument. The calculated argument corresponds to the phase difference amount ψ of the signal of each pixel 40. Therefore, from the M signal values obtained from the respective pixels 40, the phase difference amount ψ of the signal of each pixel 40 is calculated based on the equation (18), so that the refraction angle φ(x) is acquired.

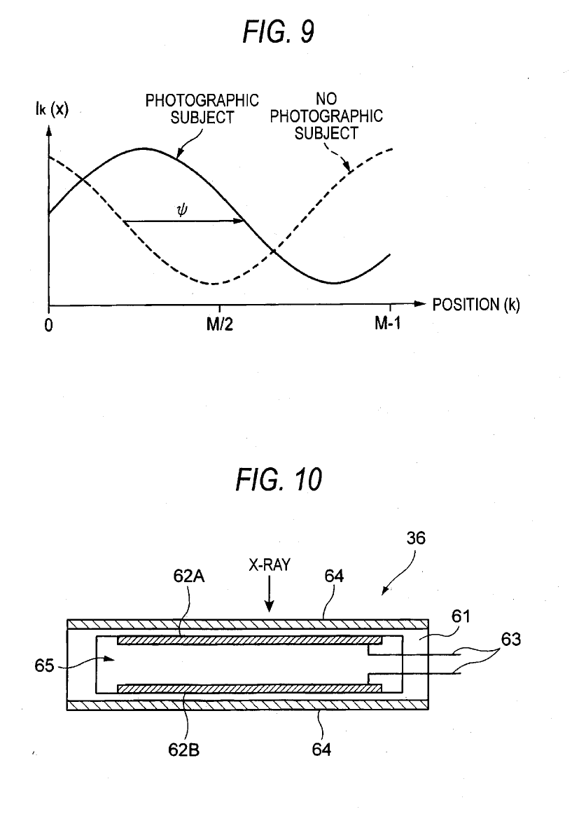

FIG. 9 shows a signal of one pixel of the radiological image detector, which is changed depending on the fringe scanning.

The M signal values obtained from the respective pixels 40 are periodically changed with the period of the grating pitch p2 with respect to the position k of the second absorption type grating 32. The broken line of FIG. 9 indicates the change of the signal value when there is no photographic subject H and the solid line of FIG. 9 indicates the change of the signal value when there is the photographic subject H. A phase difference of both waveforms corresponds to the phase difference amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis. In the above descriptions, a y coordinate of the pixel 40 in the y direction is not considered. However, by performing the same calculation for each y coordinate, it is possible to obtain the two-dimensional phase shift distribution Φ(x, y) in the x and y directions.

The above calculations are performed by the calculation processing unit 22 and the calculation processing unit 22 stores the phase contrast image in the storage unit 23.

After the operator inputs the imaging instruction through the input device 21, the respective units operate in cooperation with each other under control of the control device 20, so that the fringe scanning and the generation process of the phase contrast image are automatically performed and the phase contrast image of the photographic subject H is finally displayed on the monitor 24.

In the below, the photo timer 36 is described. FIG. 10 shows a sectional view of the photo timer 36 of an ionization chamber type. The photo timer 36 has a hollow frame 61 that is made of an insulation plate such as resin, electrodes 62A, 62B that are respectively arranged on upper and lower surfaces inside the frame 61 with respect to the incident direction of the X-ray and are made of thin aluminum or carbon having low X-ray absorption ability, two conducting wires 63 that feed a direct current voltage to the electrodes 62A, 62B and thus take out ionization current, aluminum plates 64 that are fixed on upper and lower surfaces outside the frame 61 with regard to the incident direction of the X-ray and have a reinforcement function of the frame 61 and an X-ray filter function for soft ray removal, and an ionization gas of rare gas such as Xe gas, Kr gas, Ar gas and the like that is enclosed and sealed in an internal space of the frame 61.

According to the photo timer 36 having the above structure, when the X-ray is incident into the frame 61, regarding the gas atom having absorbed the energy of the X-ray, the outermost electron is expelled beyond the gravitational sphere of an atomic nucleus thereof and thus the atom is positively charged. As the direct current voltage is applied to the electrodes 62A, 62B, the electrons and the positively charged atoms are captured by the electrodes 62A, 62B, respectively and taken out as signal currents indicating the X-ray dose.

In the meantime, the photo timer 36 may be a fluorescence lighting type, a semiconductor type and the other types as well as the above ionization chamber type. Also, the light receiving area of the photo timer 36 may be a part of the FPD 30 or may cover a whole light receiving surface of the FPD 30.

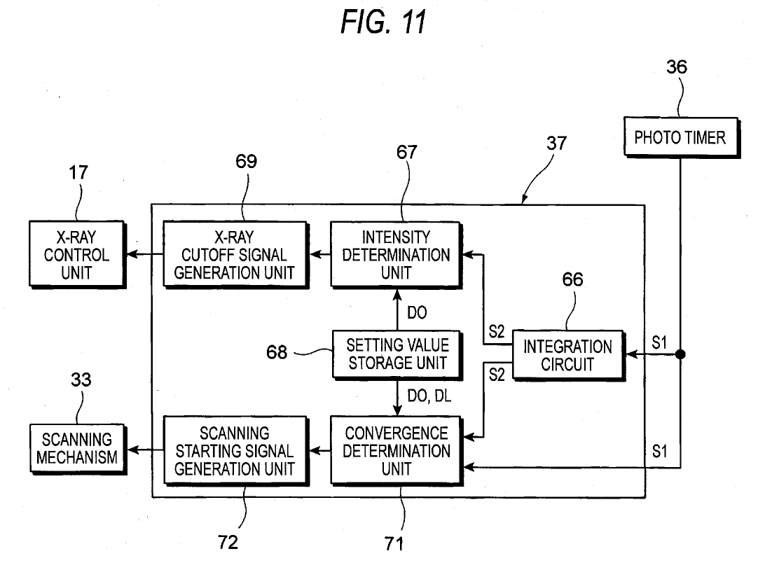

FIG. 11 shows a control block diagram when an exposure control is performed by using the photo timer 36.

The photo timer 36 detects the X-ray, which is emitted from the X-ray source 11 at conditions of predetermined tube voltage, tube current and X-ray irradiation time and has passed through the photographic subject H, the first and second absorption type gratings 31, 32 and the scattering removal grating 34, and generates the signal current. The signal current that is output by the photo timer 36 is proportional to the radiation dose of the X-ray incident onto the photo timer 36 and an integrated intensity of the signal current is proportional to an exposure amount of the FPD 30. Accordingly, the exposure control unit 37 adds the signal current value from the photo timer 36 and thus calculates the integrated intensity, acquires a timing at which the FPD 30 reaches a predetermined X-ray exposure amount and performs a control of stopping the irradiation of the X-ray from the X-ray source 11 at the acquired timing. That is, the exposure control unit 37 functions as an X-ray irradiation stopping unit that stops the irradiation of the X-ray toward the imaging unit 12 when the integrated intensity indicating the exposure amount of the X-ray reaches a predetermined radiation dose setting value.

A specific sequence is as follows. First, the photo timer 36 outputs the signal current, which is generated by the irradiation of the X-ray, to an integration circuit 66 of the exposure control unit 37. The integration circuit 66 integrates the input signal current to calculate an integrated intensity and outputs the same to an intensity determination unit 67. The intensity determination unit 67 compares the input integrated intensity signal of the signal current with a radiation dose setting value DO pre-stored in a setting value storage unit 68 and generates an X-ray cutoff signal from an X-ray cutoff signal generation unit 69 when the integrated intensity signal is the radiation dose setting value DO or larger. The X-ray cutoff signal is transmitted to the X-ray source control unit 17, so that the generation of the X-ray from the X-ray tube 18 is stopped by the high voltage generator 16 shown in FIG. 2. Thereby, the X-ray exposure amount of the FPD 30 is controlled.

Also, the exposure control unit 37 also performs a control of excluding the influence of the wave tail generated in the tube voltage waveform for the X-ray source 11, in addition to the exposure control of using the photo timer 36.

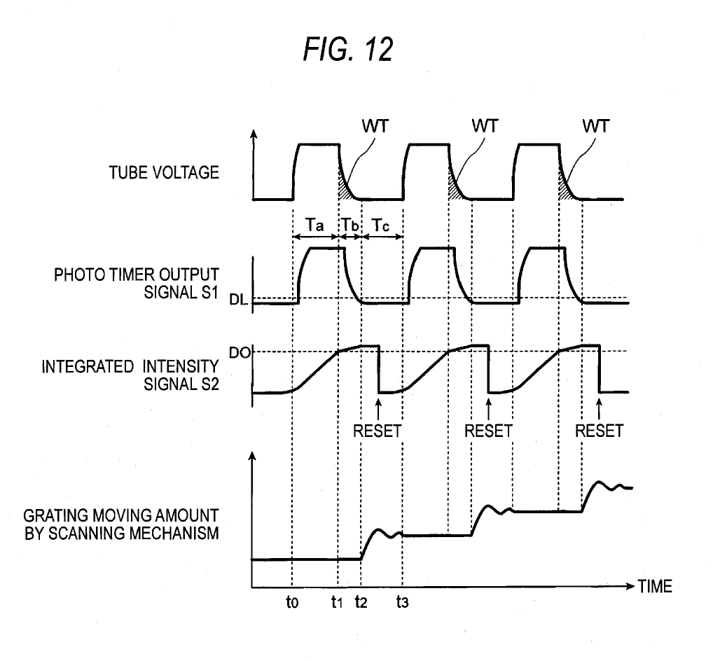

FIG. 12 illustrates a relation of a waveform of a tube voltage that is applied to the X-ray source 11, a detection signal of the photo timer 36 and a moving amount of a grating by the scanning mechanism 33. When predetermined voltage and current are supplied to the X-ray source 11, the charges are accumulated in the cable connecting from the power supply unit to the X-ray tube, and the like. Due to the accumulated charges, when the voltage is dropped in applying the tube voltage of a pulse shape, the tube voltage becomes not zero instantaneously and is exponentially decreased, i.e., a so-called wave tail WT is generated.

When the wave tail WT is generated in the tube voltage waveform, the X-ray source 11 continuously outputs the X-ray without stopping the output of the X-ray in the period of the wave tail WT.

In the meantime, as described above, while the scanning mechanism 33 stepwise translation-moves one of the first and second absorption type gratings 31, 32 relatively to the other in the x direction, the FPD 30 performs the imaging at the positions of the respective moving destinations. At this time, the moving speed of the first and second absorption type gratings 31, 32 by the scanning mechanism 33 is exceedingly responsive at the time of the moving startup, so that the moving speed is not the constant speed.

Therefore, if the FPD 40 detects the X-ray by the wave tail at the time of rising at which the moving speed is excessively responsive, the change of the moiré by the difference of the distance between the first and second absorption type gratings 31, 32 being moving is caused. The change of the moiré is superimposed on the original moiré by the phase difference/refractive index difference. Thereby, when generating the phase contrast image, a calculation error is caused in the calculation process of the captured fringe images. As a result, the contrast or resolution is lowered, the artifact in which the variation of the moiré fringe cannot be perfectly removed or unstable non-uniformity is generated is caused, or only a phase contrast image whose diagnosis ability is remarkably low is obtained.

Therefore, in the X-ray imaging system of this illustrative embodiment, in order to exclude the influence of the wave tail WT of the tube voltage waveform, the scanning mechanism 33 is controlled not to perform the relative displacement of the first and second absorption type gratings 31, 32 until the tube voltage is dropped to a level that does not substantially influence an image. Here, the level that does not substantially influence an image means that the tube voltage becomes 5% or smaller of a set value, preferably 1% or smaller, and more preferably 0.1% or smaller. Alternatively, it means that the output of the X-ray per unit time becomes 5% or smaller of an output per unit time within a set irradiation time period, preferably 1% or smaller, and more preferably 0.1% or smaller. Alternatively, it means that it becomes time of three times or larger and ten times or smaller, preferably five times or larger and ten times or smaller, and more preferably seven times or larger and ten times or smaller than the time constant t of the X-ray system.

That is, as shown in FIG. 12, during a time period Tₐ from a timing tₒ at which the tube voltage increases to a timing t₁ at which the tube voltage starts to decrease and a time period T_{b} in which the X-ray is continuously generated by the wave tail WT from the timing t₁ at which the tube voltage starts to decrease, the FPD 30 detects the X-ray while the scanning mechanism 33 does not perform the relative displacement of the first and second absorption type gratings 31, 32. During a time period T_{c} from a timing t₂ at which the generation of the X-ray by the wave tail WT disappears and the tube voltage is returned to the level before the ascent to a next timing t₃ at which the tube voltage starts to increase, the driving of the scanning mechanism 33 is initiated to complete the relative displacement of the first and second absorption type gratings 31, 32.

The time period T_{b} during which the wave tail WT is generated is determined based on the signal current (hereinafter, referred to as ‘output signal’) that is output by the photo timer 36. That is, the output signal from the photo timer 36, which is proportional to the tube voltage, is input to the integration circuit 66 of the exposure control unit 37, as shown in FIG. 11. The integration circuit 66 integrates the input output signal S1 to calculate an integrated intensity signal S2 and outputs the calculated integrated intensity signal S2 to both the intensity determination unit 67 and a convergence determination unit 71.

The convergence determination unit 71 receives the integrated intensity signal S2 that is input from the integration circuit 66, refers to the radiation dose setting value DO pre-stored in the setting value storage unit 68, detects whether the integrated intensity signal S2 reaches the radiation dose setting value DO, as shown in FIG. 12, and calculates the timing t₁ at which the integrated intensity signal S2 reaches the radiation dose setting value DO. Then, the convergence determination unit 71 detects a timing at which the integrated intensity signal S2 after the timing t1 is gradually increased due to the influence of the wave tail WT and converges into a constant value. It is possible to conveniently determine whether the integrated intensity signal S2 converges into a constant value by determining whether the output signal S1 from the photo timer 36 is decreased to the radiation dose or smaller that does not have a substantial effect on the image of the FPD 30. Regarding the convergence setting value DL, the optimal values thereof depending on the imaging conditions such as types of the FPD 30 are pre-stored in the setting value storage unit 68 and are appropriately referred and used.

In the meantime, it may be also possible to determine whether the integrated intensity signal S2 converges into a constant value by calculating a time differential value of the output signal S1 from the photo timer 36 or the integrated intensity signal S2 and detecting whether the time differential value becomes a predetermined setting value or smaller (for example, zero).

As described above, the time period from the timing t₁ at which the integrated intensity signal S2 reaches the radiation dose setting value DO to the timing t₂ at which the output signal S1 reaches the convergence setting value DL or smaller is detected as the time period T_{b} during which the wave tail WT is generated.

Then, after the time period T_{b} during which the wave tail WT is generated has elapsed, i.e., when the convergence determination unit 71 shown in FIG. 11 determines that the integrated intensity signal S2 reaches the radiation dose setting value DO and the output signal S1 becomes the convergence setting value DL or smaller, the convergence determination unit 71 outputs a timing signal to a scanning starting signal generation unit 72. Also, the scanning starting signal generation unit 72 outputs a scanning starting signal to the scanning mechanism 33.

When the scanning mechanism 33 receives the scanning starting signal to start the operation of relatively moving the first and second absorption type gratings 31, 32, the moving amount of the absorption type grating is changed from the timing t2 and causes a vibration by the excessive response at the early stage of the operation. Then, the absorption type grating is stopped and maintained at a position of a desired moving destination after the vibration converges.

In the meantime, the integration circuit 66 resets the integrated value of the integrated intensity signal S2 during the time period T_{c} so that the output signal S1 from the photo timer 36 at the time of next imaging can be integrated from the reset state. Then, the exposure of the FPD 30 and the moving of the absorption type grating are performed at the next moving destination in the same manner as the above.

According to the above exposure control, the scanning mechanism 33 performs the driving operation of the relative displacement of the first and second absorption type gratings 31, 32 in the time period in which the radiation dose detection value of the X-ray, which is detected in the photo timer 36, is attenuated to the radiation dose value that does not substantially influence the image of the FPD 30. Therefore, during the exposure period of the FPD 30 at the respective moving destinations of the relative displacement, the first and second absorption type gratings 31, 32 are not relatively moved. Thus, the imaging by the FPD 30 is not performed at the timing at which the moving speed of the relative displacement of the first and second absorption gratings 31, 32 is excessively responsive and thus the moiré is highly in disorder. As a result, it is possible to detect the primary moiré fringe accurately and stably.

Accordingly, the phase contrast image, which is obtained by the calculation processing without the influence of the wave tail on the moiré fringe of the captured image, has the quality that is suitable for the diagnosis with the high contrast and resolution, owing to the improved phase restoring accuracy thereof.

According to the X-ray imaging system 10 of this illustrative embodiment, when the FPD 30 performs the imaging after the first and second absorption type gratings 31, 32 are relatively moved and stopped at desired positions, the timing at which the wave tail converges is detected. Thereby, it is possible to initiate the relative moving to a next moving destination with minimum necessary waiting time. Therefore, it is possible to complete the plurality of imaging in a short time without waiting beyond necessity that the wave tail of the tube voltage naturally converges, so that it is possible to suppress the shaking problem caused due to the moving of the patient to the minimum. In particular, when performing a plurality of imaging with respect to the X-ray phase imaging, the imaging should be performed in a short time because a patient cannot typically keep still for a long time due to the diseases and is thus apt to move, in many cases. Therefore, the effect that the plurality of imaging can be completed in a short time is significant.

Also, according to the X-ray imaging system 10, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L2 from the first absorption type grating 31 to the second absorption type grating 32 and to set the distance L2 to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is thus improved, it is possible to improve the detection sensitivity of the phase contrast image.

Also, in the X-ray imaging system 10, the refraction angle φ is calculated by performing the fringe scanning for the projection image of the first grating. Thus, it has been described that both the first and second gratings are the absorption type gratings. However, the invention is not limited thereto. As described above, the invention is also useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe, such as method of using Fourier transform/inverse Fourier transform known in “J. Opt. Soc. Am. Vol. 72, No. 1 (1982) p.156”, may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

In addition, it may be possible to prepare a phase differential image (differential amount of the phase shift distribution Φ) from an image group that is acquired by performing the imaging (pre-imaging) at a state in which there is no photographic subject. The phase differential image reflects the phase non-uniformity of a detection system (that is, the phase differential image includes a phase difference by the moiré, a grid non-uniformity, a refraction of a radiation dose detector, and the like). Also, by preparing a phase differential image from an image group that is acquired by performing the imaging (main imaging) at a state in which there is a photographic subject and subtracting the phase differential image acquired in the pre-imaging from the phase differential image acquired in the main imaging, it is possible to acquire a phase differential image in which the phase non-uniformity of a measuring system is corrected.

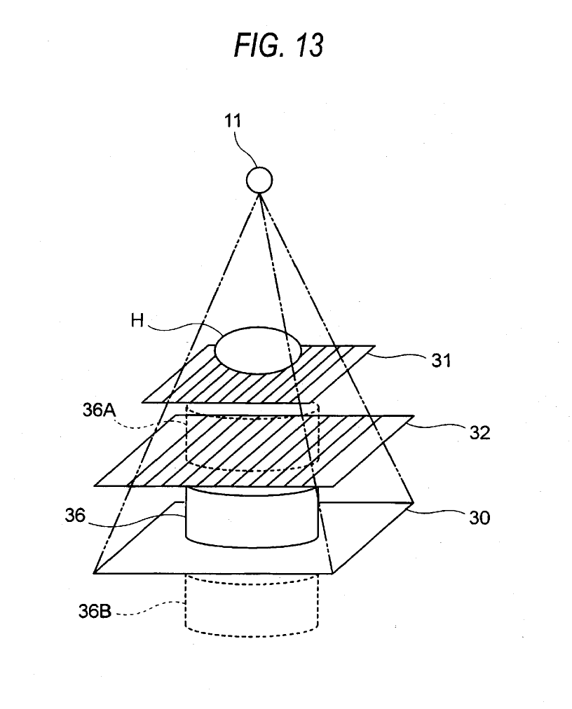

In the above configuration, the photo timer 36 is arranged between the second absorption type grating 32 and the FPD 30. However, the invention is not limited thereto. For example, as shown in FIG. 13, a photo timer 36A may be arranged between the first absorption type grating 31 and the second absorption type grating 32. According to this configuration, it is possible to shorten a distance between the X-ray source 11 and the photo timer 36A and to substantially enlarge the detection range of the photo timer 36A on the FPD 30. Also, a photo timer 36B may be arranged at an opposite side to the second absorption type grating 32 of the FPD 30. According to this configuration, it is possible to prevent a shadow by the photo timer 36B from being projected on the FPD 30.

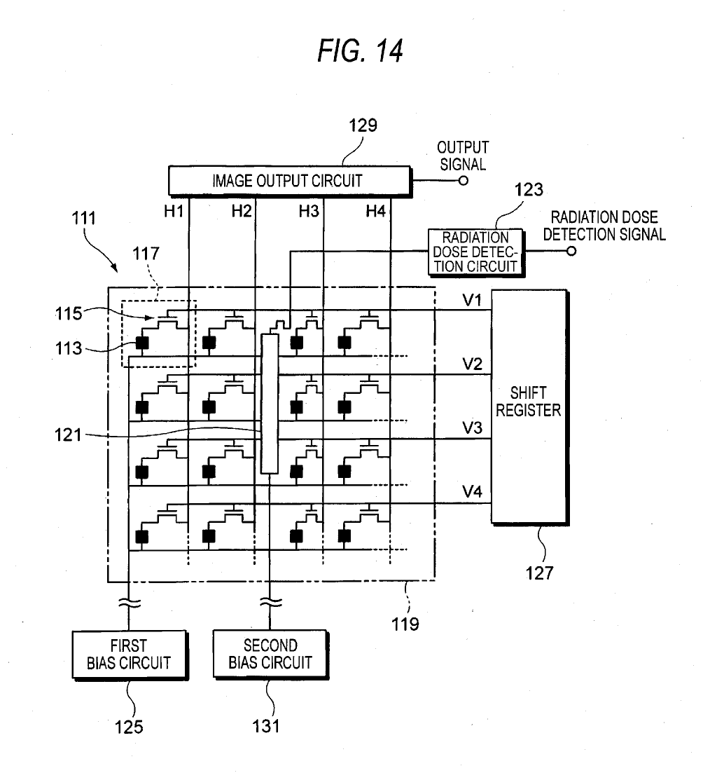

In the below, a modified embodiment of the X-ray imaging system is described in which an X-ray detection unit is provided in the FPD instead of the photo timer 36. FIG. 14 is a circuit diagram of an imaging circuit 111 of the FPD in this illustrative embodiment. In the imaging circuit 111, a plurality of pixels 117, each of which has a first photoelectric conversion device 113 that converts the X-ray into charges and a thin film transistor 115 that is a switch device connected to the first photoelectric conversion device, is arranged in a two-dimensional matrix shape on a photoelectric conversion substrate 119, thereby configuring a photoelectric conversion unit. Also, the imaging circuit 111 has a second photoelectric conversion device 121 that is an X-ray detection unit and a radiation dose detection circuit 123 that is connected to the second photoelectric conversion device and detects a radiation dose of the X-ray incident into the photoelectric conversion unit. In FIG. 14, 16 pixels of four cells by four cells are shown for illustration convenience sake.

The first photoelectric conversion devices 113 are connected to a first bias circuit 125, and gates of the thin film transistors 115 are connected to a shift register 127 through gate lines V1 to V4 at each line. Also, output signals of the thin film transistors 115 are transmitted to an image output circuit 129 including an amplifier, a multiplexer, an A/D converter and the like through signal lines H1 to H4 at each column. That is, the charges that are generated in the first photoelectric conversion devices 113 corresponding to a line selected by the shift register 127 are read out, as an electric signal corresponding to the charges, at a predetermined timing through the thin film transistors 115 and then transmitted to the image output circuit 129.

In the meantime, the second photoelectric conversion device 121 is arranged between the signal lines of the column direction between the pixels 117 of the photoelectric conversion substrate 119, separately from the first photoelectric conversion devices 113 for capturing a typical image. The second photoelectric conversion device 121 is connected to a second bias circuit 131. When reading out the charges, the second photoelectric conversion device can always output the charges depending on the radiation dose of the incident X-ray, without being selected by the shift register 127. Accordingly, the constant potential is always applied. The charges detected by the second photoelectric conversion device 121 are output as a radiation detection signal through the radiation dose detection circuit 123.

According to the above configuration, it is not necessary to separately provide the X-ray detection unit from the FPD so as to provide the second photoelectric conversion device 121 becoming the X-ray detection unit in the photoelectric conversion substrate 119. Thereby, it is possible to miniaturize the X-ray image detection apparatus and to configure the circuit simply and easily. In the meantime, in addition to the above configuration in which the X-ray detection unit is provided in the FPD, i.e., the configuration of the FPD 30 in which the pixels, each of which includes the photoelectric conversion devices that convert the X-ray into the charges and the thin film transistors that are connected to the photoelectric conversion devices and output the electric signals corresponding to the charges at a predetermined timing, are arranged in the matrix shape on the semiconductor substrate and the second photoelectric conversion device 121, which is the X-ray detection unit, is arranged between the first photoelectric conversion devices 113 so that the X-ray detection unit is arranged in the pixel area consisting of the plurality of pixels on the semiconductor substrate, a configuration may be possible in which at least some of the first photoelectric conversion devices 113 are used as the X-ray detection unit or a dedicated X-ray detection unit is arranged at a location except for the photoelectric conversion substrate 119.

Also, the radiation dose detection signal is transmitted to the exposure control unit 37 shown in FIG. 11. Like the output signal from the photo timer 36, the X-ray cutoff signal and the scanning starting signal are generated depending on the determination results of the intensity determination unit 67 and the convergence determination unit 71, so that the exposure control is performed.

FIG. 14 shows another example of the radiographic system for illustrating an illustrative embodiment of the invention.

A mammography apparatus 80 shown in FIG. 14 is an apparatus of capturing an X-ray image (phase contrast image) of a breast B that is the photographic subject. The mammography apparatus 80 includes an X-ray source accommodation unit 82 that is mounted to one end of an arm member 81 rotatably connected to a base platform (not shown), an imaging platform 83 that is mounted to the other end of the arm member 81 and a compression plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The compression plate 84 is moved by a moving mechanism (not shown) and presses the breast B between the compression plate and the imaging platform 83. At this pressing state, the X-ray imaging is performed.

Also, the collimator unit 19 is provided with the shutter unit 27, as described above, and the configurations of the X-ray source 11 and the imaging unit 12 are the same as those of the X-ray imaging system 10. Therefore, the respective constitutional elements are indicated with the same reference numerals as the X-ray imaging system 10. Since the other configurations and the operations are the same as the above, the descriptions thereof are also omitted.

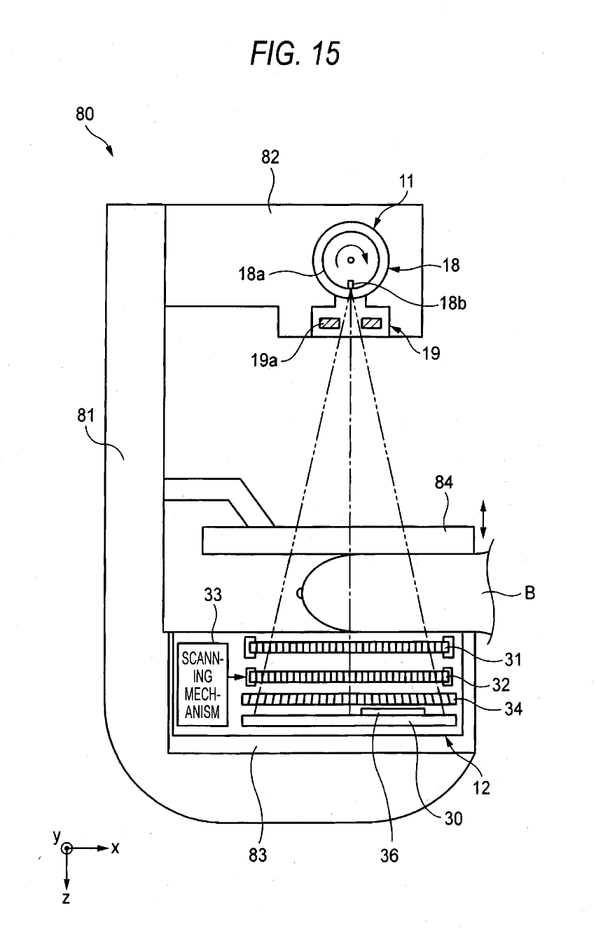

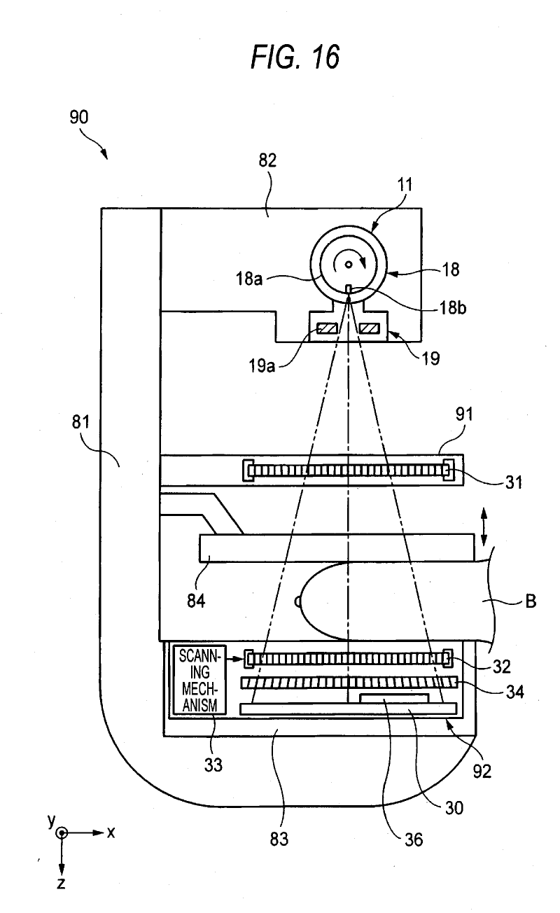

FIG. 15 shows a modified embodiment of the radiographic system of FIG. 14.

A mammography apparatus 90 shown in FIG. 15 is different from the mammography apparatus 80 in that the first absorption type grating 31 is provided between the X-ray source 11 and the compression plate 84. The first absorption type grating 31 is accommodated in a grating accommodation unit 91 that is connected to the arm member 81. An imaging unit 92 is configured by the FPD 30, the second absorption type grating 32 and the scanning mechanism 33.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also with the mammography apparatus 90, it is possible to obtain the phase contrast image of the object to be diagnosed B by the above-described principle.

In the mammography apparatus 90, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the above mammography apparatus 80. In the meantime, like the mammography apparatus 90, the configuration in which the object to be diagnosed is arranged between the first absorption type grating 31 and the second absorption type grating 32 can be applied to the above X-ray imaging system 10.

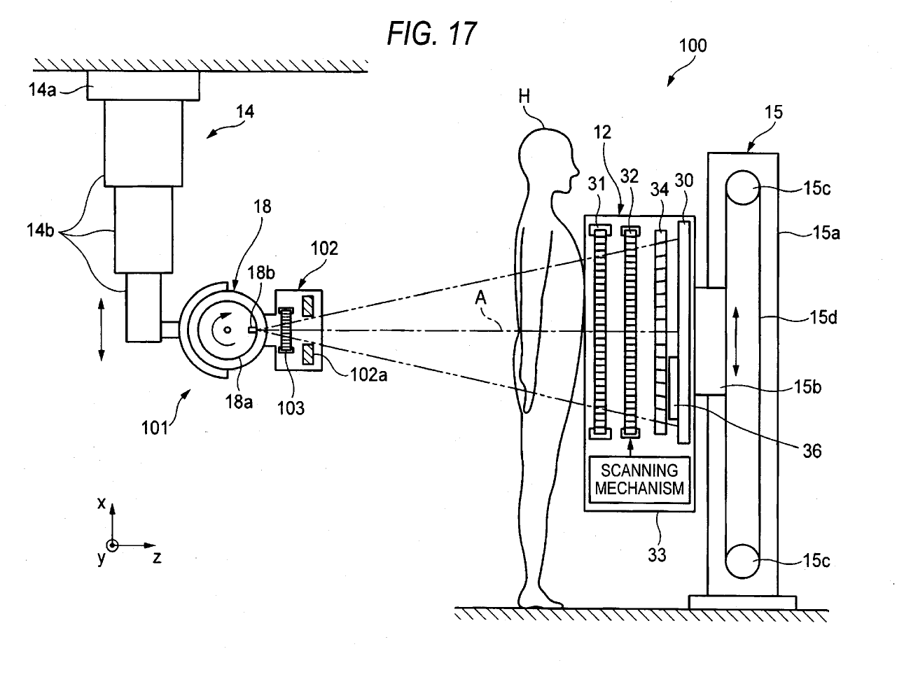

FIG. 17 shows another example of the radiographic system for illustrating an illustrative embodiment of the invention.

A radiographic system 100 is different from the radiographic system 10 in that a multi-slit 103 is provided to a collimator unit 102 of an X-ray source 101. Since the other configurations are the same as the above X-ray imaging system 10, the descriptions thereof are omitted.

In the above X-ray imaging system 10, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focus 18b, so that the quality of the phase contrast image may be deteriorated. Accordingly, it may be considered that a pin hole is provided just after the X-ray focus 18b to effectively reduce the focus size. However, when an opening area of the pin hole is decreased so as to reduce the effective focus size, the X-ray intensity is lowered. In the X-ray imaging system 100 of this illustrative embodiment, in order to solve this problem, the multi-slit 103 is arranged just after the X-ray focus 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation emitted from the X-ray source 11, thereby reducing the effective focus size in the x direction and forming a plurality of point light sources (disperse light sources) in the x direction.

It is necessary to set a grating pitch p3 of the multi-slit 103 so that it satisfies a following equation (19), when a distance from the multi-slit 103 to the first absorption type grating 31 is L3.

$$\begin{matrix}[ equation 19 ] & \\ {p}_{3} = \frac{{L}_{3}}{{L}_{2}} {p}_{2} & ( 19 )\end{matrix}$$

The equation (19) is a geometrical condition so that the projection images (G1 images) of the X-rays, which are emitted from the respective point light sources dispersedly formed by the multi-slit 103, by the first absorption type grating 31 coincide (overlap) at the position of the second absorption type grating 32.

Also, since the position of the multi-slit 103 is substantially the X-ray focus position, the grating pitch p2 and the interval d2 of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Like this, in the X-ray imaging system 100 of this illustrative embodiment, the G1 images based on the point light sources formed by the multi-slit 103 overlap, so that it is possible to improve the quality of the phase contrast image without lowering the X-ray intensity. The above multi-slit 103 can be applied to any of the X-ray imaging systems.

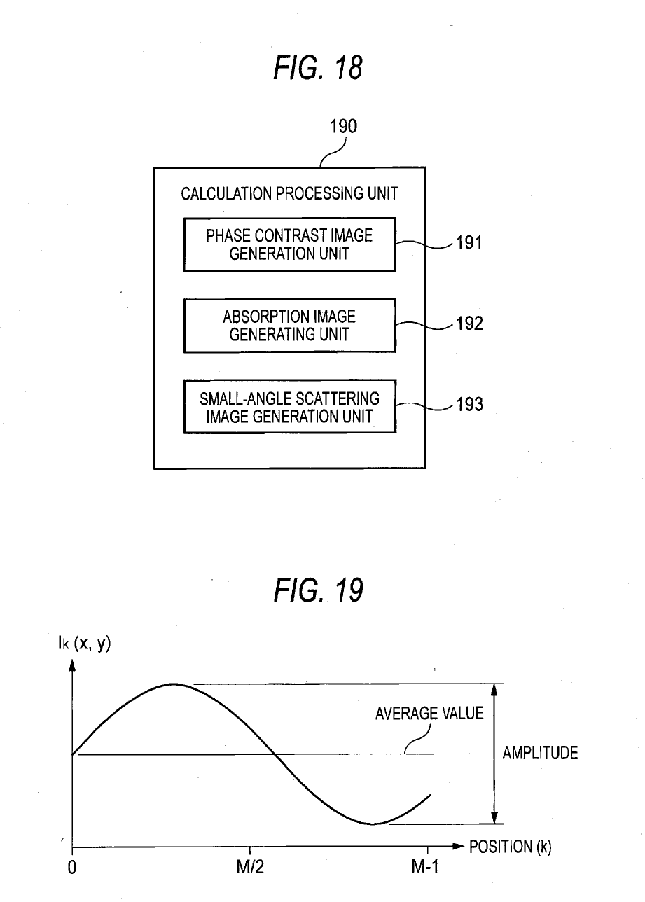

FIG. 18 shows another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent tissue characterization and state caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the absorption image and the small-angle scattering image to be generated from a plurality of images acquired for the phase contrast image. Since the other configurations are the same as the above X-ray imaging system 10, the descriptions thereof are omitted. The calculation processing unit 190 has a phase contrast image generation unit 191, an absorption image generation unit 192 and a small-angle scattering image generation unit 193. The units perform the calculation processes, based on the image data acquired at the M scanning positions of k=0, 1, 2, . . . , M−1. Among them, the phase contrast image generation unit 191 generates a phase contrast image in accordance with the above-described process.

The absorption image generation unit 192 averages the image data Ik(x, y), which is obtained for each pixel, with respect to k, as shown in FIG. 19, and thus calculates an average value and images the image data, thereby generating an absorption image. Also, the calculation of the average value may be performed simply by averaging the the image data Ik(x, y) with respect to k. However, when M is small, an error is increased. Accordingly, after fitting the image data Ik(x, y) with a sinusoidal wave, an average value of the fitted sinusoidal wave may be calculated. In addition, when generating the absorption image, the invention is not limited to the using of the average value. For example, an addition value that is obtained by adding the image data Ik(x, y) with respect to k may be used inasmuch as it corresponds to the average value.

In the meantime, it may be possible to prepare an absorption image from an image group that is acquired by performing the imaging (pre-imaging) at a state in which there is no photographic subject. The absorption image reflects a transmittance non-uniformity of a detection system (that is, the absorption image includes information such as a transmittance non-uniformity of grids, an absorption influence of a radiation dose detector, and the like). Therefore, from the image, it is possible to prepare a correction coefficient map for correcting the transmittance non-uniformity of the detection system. Also, by preparing an absorption image from an image group that is acquired by performing the imaging (main imaging) at a state in which there is a photographic subject and multiplying the respective pixels with the correction coefficient, it is possible to acquire an absorption image of the photographic subject in which the transmittance non-uniformity of the detection system is corrected.

The small-angle scattering image generation unit 193 calculates an amplitude value of the image data Ik(x, y), which is obtained for each pixel, and thus images the image data, thereby generating a small-angle scattering image. Meanwhile, the amplitude value may be calculated by calculating a difference between the maximum and minimum values of the image data Ik(x, y). However, when M is small, an error is increased. Accordingly, after fitting the image data Ik(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

In the meantime, it may be possible to prepare a small-angle scattering image from the image group that is acquired by performing the imaging (pre-imaging) at a state in which there is no photographic subject. The small-angle scattering image reflects amplitude value non-uniformity of a detection system (that is, the small-angle scattering image includes information such as pitch non-uniformity of grids, opening ratio non-uniformity, non-uniformity due to the relative position difference between the grids, and the like). Therefore, from the image, it is possible to prepare a correction coefficient map for correcting the amplitude value non-uniformity of the detection system. Also, by preparing a small-angle scattering image from an image group that is acquired by performing the imaging (main imaging) at a state in which there is a photographic subject and multiplying the respective pixels with the correction coefficient, it is possible to acquire a small-angle scattering image of the photographic subject in which the amplitude value non-uniformity of the detection system is corrected.

According to the X-ray imaging system of this illustrative embodiment, the absorption image or small-angle scattering image is generated from the plurality of images acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

As described above, the specification discloses a radiological image detection apparatus including:

a first grating;

a second grating having a period that substantially coincides with a pattern period of a radiological image formed by radiation having passed through the first grating;

a scanning means that relatively displaces at least one of the radiological image and the second grating to a plurality of relative positions at which phase differences of the radiological image and the second grating are different from each other;

a radiological image detector that detects the radiological image masked by the second grating;

a radiation detection means that is provided on a path of the radiation and detects the radiation to be irradiated to the radiological image detector, and

a control means that enables the scanning means to perform a relative displacement operation of the first grating and the second grating in a time period in which a radiation dose detection value of the radiation detected by the radiation detection means is attenuated to a radiation dose value that does not have a substantial effect on an image of the radiological image detector.

Also, according to the radiological image detection apparatus disclosed in the specification, the control means further has an integration circuit that adds radiation dose detection values of the radiation, which are sequentially detected by the radiation detection means, and thus calculates an integrated intensity, and

a radiation cutoff means that stops the irradiation of the radiation to the first grating when the integrated intensity reaches a predetermined radiation dose setting value.

Also, according to the radiological image detection apparatus disclosed in the specification, the radiation detection means is embedded in the radiological image detector.

Also, according to the radiological image detection apparatus disclosed in the specification, the radiological image detector has such a configuration that a plurality of pixels, each of which has a photoelectric conversion device that converts the radiation into charges and a thin film transistor that is connected to the photoelectric conversion device and outputs an electric signal corresponding to the charges at a predetermined timing, is arranged in a matrix shape on a semiconductor substrate, and

the radiation detection means is arranged in at least one pixel on the semiconductor substrate or in a pixel area consisting of the plurality of pixels on the semiconductor substrate.

Also, according to the radiological image detection apparatus disclosed in the specification, the radiation detection means is arranged between the second grating and the radiological image detector.

Also, according to the radiological image detection apparatus disclosed in the specification, the radiation detection means is arranged between the first grating and the second grating.

Also, according to the radiological image detection apparatus disclosed in the specification, the radiation detection means is arranged at an opposite side to the second grating of the radiological image detector.

Also, the specification discloses a radiographic apparatus including one of the radiological image detection apparatuses and a radiation source that irradiates the radiation to the radiological image detection apparatus.

Also, the specification discloses a radiographic system including the radiological image detection apparatus and a calculation processing unit that calculates, from an image detected by the radiological image detector of the radiographic apparatus, a refraction angle distribution of the radiation incident onto the radiological image detector and generates a phase contrast image of a photographic subject based on the refraction angle distribution.

What is claimed is:

1. A radiological image detection apparatus comprising:
a first grating;
a second grating that has a periodic form which substantially coincides with a pattern period of a radiological image formed by radiation having passed through the first grating;
a scanning unit that relatively displaces at least one of the radiological image and the second grating to a plurality of relative positions at which phase differences of the radiological image and the second grating are different from each other;
a radiological image detector that detects the radiological image masked by the second grating;
a radiation detection unit that is provided on a path of the radiation and detects the radiation to be irradiated to the radiological image detector, and
a control unit that allows the scanning unit to perform a relative displacement operation of the first grating and the second grating in a time period in which a radiation dose detection value of the radiation detected by the radiation detection unit is attenuated to a given level at which the radiation dose value does not have a substantial effect on an image of the radiological image detector.

2. The radiological image detection apparatus according to claim 1, wherein the control unit includes:
an integration circuit that calculates an integrated intensity by adding radiation dose detection values of the radiation which are sequentially detected by the radiation detection unit, and
a radiation cutoff unit that stops the irradiation of the radiation to the first grating when the integrated intensity reaches a predetermined radiation dose setting level.

3. The radiological image detection apparatus according to claim 1, wherein the radiation detection unit is embedded in the radiological image detector.

4. The radiological image detection apparatus according to claim 3, wherein the radiological image detector includes a plurality of pixels arranged in a matrix shape on a semiconductor substrate, each of the plurality of pixels includes a photoelectric conversion device that converts the radiation into charges and a thin film transistor that is connected to the photoelectric conversion device and outputs an electric signal corresponding to the charges at a predetermined timing, and
the radiation detection unit is arranged in at least one of the pixels on the semiconductor substrate or in a pixel area consisting of the plurality of pixels on the semiconductor substrate.

5. The radiological image detection apparatus according to claim 1, wherein the radiation detection unit is arranged between the second grating and the radiological image detector.

6. The radiological image detection apparatus according to claim 1, wherein the radiation detection unit is arranged between the first grating and the second grating.

7. The radiological image detection apparatus according to claim 1, wherein the radiation detection unit is arranged at an opposite side to the second grating of the radiological image detector.

8. A radiographic apparatus comprising:
the radiological image detection apparatuses according to claim 1, and
a radiation source that irradiates the radiation to the radiological image detection apparatus.

9. A radiographic system comprising:
the radiological image detection apparatus according to claim 8, and
a calculation processing unit that calculates, from an image detected by the radiological image detector of the radiographic apparatus, a refraction angle distribution of the radiation incident onto the radiological image detector and generates a phase contrast image of a photographic subject based on the refraction angle distribution.
